(19) United States
(12) Patent Application Publication
(10) Pub. No.: US 2026/0332578 A1
(43) Pub. Date: Oct. 22, 2026

(54) AUTHORIZATION OF NETWORK FUNCTIONS INVOLVING AN ARTIFICIAL INTELLIGENCE AGENT

(71) Applicant: Lenovo (United States) Inc., Morrisville, NC (US)

(72) Inventors: Andreas Kunz, Ladenburg (DE); Souvik Paul, Bad Homburg (DE); Sheeba Backia Mary Baskaran, Friedrichsdorf (DE)

(73) Assignee: Lenovo (United States) Inc., Morrisville, NC (US)

(21) Appl. No.: 19/630,149

(22) Filed: Mar. 26, 2026

(51) Int. Cl. H04L 9/40

(52) U.S. Cl. CPC H04L 63/083

(57) ABSTRACT

Various aspects of the present disclosure relate to authorization of network functions (NFs) involving an artificial intelligence (AI) agent. An apparatus, such as a network server with a NF, may receive a first request indicating a function goal. The NF may determine, by an AI agent and in response to authentication of the first request, a configuration tool type to perform actions associated with a target NF type to fulfill the function goal. The NF may obtain an access token authorizing access to the target NF type and access to a configuration tool NF associated with the configuration tool type. The NF may transmit a second request to perform the actions for target NFs associated with the target NF type, and receive information associated with the actions. The NF may transmit a goal fulfillment status based on the information associated with the actions.

### TECHNICAL FIELD

The present disclosure relates to wireless communications, and more specifically to authorization of network functions (NFs).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The apparatuses (e.g., NE, UE), processors, and methods of the present disclosure each have several innovative aspects, no single one of which is solely responsible for the desirable features disclosed herein.

An NE (e.g., a network server with a network function (NF)) for wireless communication is described. The NE may be configured to, capable of, or operable to perform one or more operations as described herein. For example, the NE may be configured to, capable of, or operable to receive, from a requesting NF, a first request indicating a function goal; determine, by an artificial intelligence (AI) agent and in response to authentication of the first request, a configuration tool type to perform one or more actions associated with a target NF type to fulfill the function goal; transmit, to an authorization NF, an access token request for authorization to access one or more NFs associated with at least one of the configuration tool type or the target NF type; receive, from the authorization NF, an access token response authorizing access to the target NF type and access to a configuration tool NF associated with the configuration tool type; transmit, to the configuration tool NF, a second request to perform the one or more actions for one or more target NFs associated with the target NF type; receive, from the configuration tool NF or the one or more target NFs, information associated with the one or more actions; and transmit, to the requesting NF, a goal fulfillment status based at least in part on the information associated with the one or more actions.

A processor (e.g., a standalone processor chipset, or a component of an NE) for wireless communication is described. The processor may be configured to, capable of, or operable to perform one or more operations as described herein. For example, the processor may be configured to, capable of, or operable to receive a first request indicating a function goal; determine, by an AI agent and in response to authentication of the first request, a configuration tool type to perform one or more actions associated with a target NF type to fulfill the function goal; transmit an access token request for authorization to access one or more NFs associated with at least one of the configuration tool type or the target NF type; receive an access token response authorizing access to the target NF type and access to a configuration tool NF associated with the configuration tool type; transmit a second request to perform the one or more actions for one or more target NFs associated with the target NF type; receive information associated with the one or more actions; and transmit a goal fulfillment status based at least in part on the information associated with the one or more actions.

A method performed or performable by an NE (e.g., a network server with a NF) for wireless communication is described. The method may include receiving, from a requesting NF, a first request indicating a function goal; determining, by an AI agent and in response to authentication of the first request, a configuration tool type to perform one or more actions associated with a target NF type to fulfill the function goal; transmitting, to an authorization NF, an access token request for authorization to access one or more NFs associated with at least one of the configuration tool type or the target NF type; receiving, from the authorization NF, an access token response authorizing access to the target NF type and access to a configuration tool NF associated with the configuration tool type; transmitting, to the configuration tool NF, a second request to perform the one or more actions for one or more target NFs associated with the target NF type; receiving, from the configuration tool NF or the one or more target NFs, information associated with the one or more actions; and transmitting, to the requesting NF, a goal fulfillment status based at least in part on the information associated with the one or more actions.

In some implementations of the NE, the processor, and the method described herein, the first request is received in response to the requesting NF obtaining authorization from the authorization NF to access the NF. In some implementations of the NE, the processor, and the method described herein, the first request includes one or more of an access token of the requesting NF to the NF, a type of the function goal, one or more goal parameters, an expiry time, or a client credentials assertion (CCA) associated with the requesting NF.

In some implementations, the NE, the processor, and the method may further be configured to, capable of, or operable to validate the access token of the requesting NF to the NF and the CCA associated with the requesting NF.

In some implementations of the NE, the processor, and the method described herein, the configuration tool type and the one or more actions associated with the target NF type are identified in one or more action parameters.

In some implementations, the NE, the processor, and the method may further be configured to, capable of, or operable to generate, using the AI agent, a CCA associated with the NF that is valid for a single invocation of the configuration tool NF.

In some implementations of the NE, the processor, and the method described herein, the access token request includes one or more of a type of the function goal, one or more goal parameters, the configuration tool type, the target NF type, an expiry time, a CCA associated with the requesting NF, or a CCA associated with the NF. In some implementations of the NE, the processor, and the method described herein, the access token response includes an access token of the NF to the configuration tool NF, and an access token of the configuration tool NF to the one or more target NFs associated with the target NF type.

In some implementations of the NE, the processor, and the method described herein, the one or more target NFs are determined by either the authorization NF or the configuration tool NF.

In some implementations of the NE, the processor, and the method described herein, the second request includes one or more of an access token of the NF to the configuration tool NF, an access token of the configuration tool NF to the one or more target NFs associated with the target NF type, a list of the one or more target NFs, the target NF type, a type of the function goal, one or more goal parameters, a CCA of the requesting NF, a CCA of the NF, or one or more action parameters associated with the one or more actions.

In some implementations of the NE, the processor, and the method described herein, the information associated with the one or more actions includes one or more access tokens of the one or more target NFs to the NF.

In some implementations, the NE, the processor, and the method may further be configured to, capable of, or operable to determine, by the AI agent based at least in part on the first request, one or more additional actions associated with the target NF type, in response to the function goal not being fulfilled by the one or more actions and an expiry time not being reached; and transmit, to the authorization NF, another access token request for the one or more additional actions.

### BRIEF DESCRIPTION OF THE DRAWINGS

FIG. 1 illustrates an example of a wireless communications system in accordance with aspects of the present disclosure.

FIG. 2 illustrates an example environment of interactions between network functions (NFs), in accordance with aspects of the present disclosure.

FIG. 3 illustrates an example procedure of authorization of NFs involving an AI agent, in accordance with aspects of the present disclosure.

FIG. 4 illustrates an example procedure of authorization of NFs involving an AI agent, in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates an example of a flowchart of a method performed by an NE in accordance with aspects of the present disclosure.

### DETAILED DESCRIPTION

In a wireless communications system, a UE and an NE (e.g., a base station, gNB, or a network server with a network function (NF)) may support wireless communication (e.g., reception and/or transmission of wireless communication) using time-frequency resources.

The integration of autonomous reasoning entities, such as AI agents, into wireless communication networks introduces complex security and authorization challenges. Conventional authorization frameworks often rely on static or long-lived credentials that may not adequately supervise the granular, iterative decision-making processes of an AI agent. Without specific technical measures to authorize individual actions derived from an AI agent's reasoning, a network may be vulnerable to unauthorized modifications, privilege escalation, or autonomous actions that deviate from intended network goals.

Aspects of the present disclosure are described in the context of a wireless communications system. As described herein, to provide solutions to facilitate supervised authorization of an AI agent, a NF (e.g., an AI agent) may receive, from a requesting NF, a first request indicating a functional goal. In response to authentication of the first request, the NF determines, by an AI agent based on the first request, a configuration tool type and actions to be performed for a target NF type to fulfill the functional goal. To ensure these AI agent outputs remain within authorized boundaries, an authorization NF (e.g., an authorization server) authorizes the determined actions and configuration tool type, and provides a configuration tool NF to the NF based on the configuration tool type. In implementations, the authorization process includes the generation of a CCA by the NF that is valid for a single round of invocation of the configuration tool NF. Upon authorization, the NF invokes the configuration tool NF to perform the determined actions in target NFs of the target NF type. In the case that the functional goal is not fulfilled by performing these actions, the NF may repeat the above processes until the functional goal is fulfilled or an expiry time is reached. By repeating these authorization and invocation steps for each round of reasoning, the authorization NF maintains continuous oversight of the actions performed by the AI agent to fulfill the functional goal.

By performing the described techniques, a wireless communications system provides enhanced security and operational control for autonomous network operations. The use of a supervised authorization loop enables a central authorization authority, such as a network repository function (NRF), to validate the specific outputs of an AI agent's reasoning process (e.g., determined actions or configuration tool types) before they are executed within a wireless network. Furthermore, the generation of short-lived credentials and transaction-specific access tokens ensures that authorization is restricted, thereby preventing the persistent use of privileges for unauthorized actions. The described techniques mitigate the risk of an AI agent performing unintended or malicious modifications to network resources, providing a robust framework for integrating autonomous reasoning into a zero trust network architecture.

Aspects of the present disclosure are described in the context of a wireless communications system. In the wireless communications system, a UE and an NE (e.g., a base station, gNB, network entity, network node, or a network server with a NF) may support wireless communication, including reception and/or transmission of wireless communication using time-frequency resources. For example, the UE and the NE may support communicating signals (e.g., carrying control information, data, or the like). It should be understood that various terms may be used interchangeably with “communicating,” such as “signaling,” “transmitting,” “receiving,” “outputting,” “forwarding,” “relaying,” “retrieving,” “obtaining,” and so forth.

Additional aspects of the present disclosure are described in the context of component diagrams, process flows, method flowcharts, etc. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein, but is to be accorded the broadest scope consistent with the principles and novel features disclosed herein.

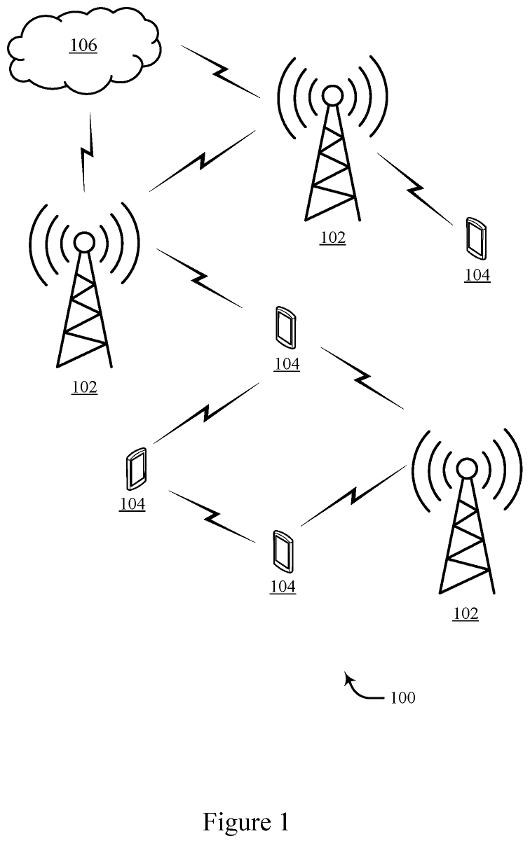

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a NF, a network entity, infrastructure, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more NFs of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

An NE 102 and a UE 104 in the wireless communications system 100 may support aspects of the described techniques for authorization of NFs involving an AI agent. According to implementations, one or more of the NEs 102 and the UEs 104 are operable to implement various aspects of the techniques described with reference to the present disclosure. For example, an NE 102 (e.g., a network server with a NF) receives a first request indicating a function goal; determines, by an AI agent and in response to authentication of the first request, a configuration tool type to perform one or more actions associated with a target NF type to fulfill the function goal; transmits an access token request for authorization to access one or more NFs associated with at least one of the configuration tool type or the target NF type; receives an access token response authorizing access to the target NF type and access to a configuration tool NF associated with the configuration tool type; transmits a second request to perform the one or more actions for one or more target NFs associated with the target NF type; receives information associated with the one or more actions; and transmits a goal fulfillment status based at least in part on the information associated with the one or more actions.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

AI agents are modern techniques for autonomous handling of complex tasks across various environments. In a study on 6G (e.g., in 3GPP in TR 22.870), several use cases are identified that utilize AI agents. These use cases cover a variety of scenarios in categories such as intelligent 6G services, device-network collaboration, multiple-device collaboration, and network-application collaboration. AI agents have the capability to fulfill a given functional goal and complex tasks by communicating with other AI agents, tools, NFs, and applications, and taking decisions accordingly.

Within mobile networks, while AI agents may be utilized for diverse use cases and scenarios, the integration of AI agents for autonomous problem-solving presents unique challenges. The capability of an AI agent to perform reasoning on a specific goal and to autonomously determine which tools to utilize and the manner of such utilization may introduce vulnerabilities. For example, without sufficient oversight, an AI agent could potentially be compromised or misconfigured, resulting in unauthorized or detrimental actions within a mobile network.

Technical analyses have identified different vulnerabilities and attack scenarios and proposed mitigation guidelines accordingly. One particular issue in the context of mobile networks is “identity and privilege abuse,” which may lead to vulnerabilities such as un-scoped privilege inheritance, cross-agent trust exploitation (e.g., confused deputy), time-of-check to time-of-use (TOCTOU) in agent workflows, and synthetic identity injection.

While general mitigation and prevention guidelines may exist, such guidelines are often high-level and generic, and there is a lack of specific description on how those would integrate into a mobile network. Accordingly, despite the high-level recommendations, a need exists for technical security measures to supervise and authorize the individual stages of the decision-making and execution processes of an AI agent within a mobile network.

To address this need, the present disclosure describes techniques for supervised authorization of an AI agent within a wireless network. In one or more implementations, the described techniques implement a multi-stage authorization loop where an authorization server (e.g., a NRF) verifies specific technical actions and tool types determined by the AI agent through an autonomous reasoning process. This oversight is facilitated by the generation of short-lived, round-specific credentials and nested access tokens that propagate the identity of a requesting NF to a target NF (e.g., a service producer). By requiring per-action authorization and providing end-to-end transparency of the authorization chain, the described techniques provide a scalable security mechanism for integrating autonomous reasoning into a service-based architecture.

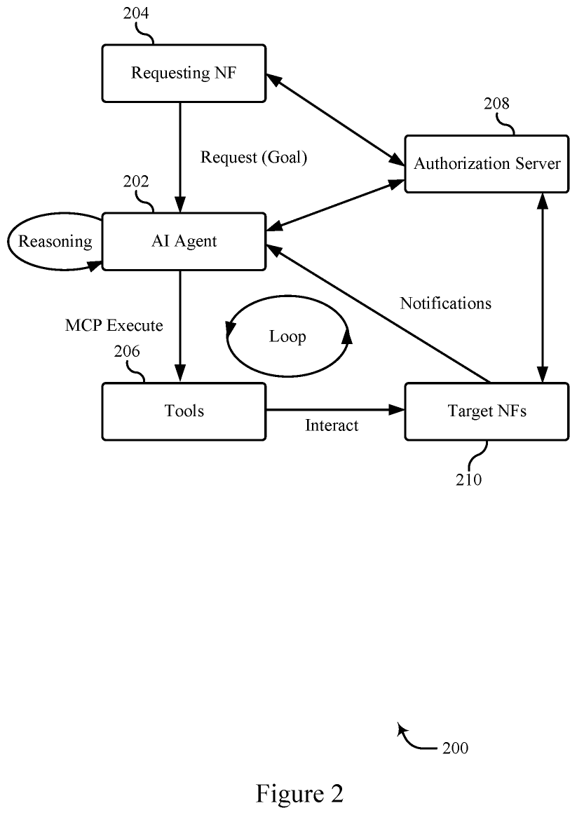

FIG. 2 illustrates an example environment 200 of interactions between NFs in accordance with aspects of the present disclosure. In this example, a high-level deployment of an AI agent 202 and corresponding tools 206 within a network (e.g., a mobile network) is shown, illustrating an example architecture of integrating AI agents into a mobile network with service based interfaces. A requesting NF 204 (e.g., a user associated with an operations, administration, and maintenance (OAM) system) formulates a specific request indicating a functional goal for the AI agent 202 to achieve. In one or more implementations, the goal may include, for example, statements such as: “achieve better quality of service (QoS) for the best effort services now running in the city for the next 3 hours,” “perform strict slice separation of Service X in all AMFs,” “verify authentication status of third party service Y on slice Z (e.g., secondary authentication verification or slice authentication verification),” or “perform load balancing between base stations in a certain area.”

As shown in FIG. 2, the requesting NF 204 may query an authorization server 208 (e.g., an authorization NF such as NRF) to retrieve or identify the AI agent 202 for achieving the functional goal and transmits the request to the AI agent 202. The AI agent 202 processes the request utilizing a reasoning procedure (e.g., a large language model (LLM) reasoning procedure) and queries the authorization server to request access for inferred tools 206 and target NFs 210. Upon access being granted, the AI agent 202 may utilize a model context protocol (MCP) to communicate with one or more selected tools 206 (e.g., a configuration tool NF) and execute one or more actions to the target NFs 210 to achieve the functional goal from the requesting NF 204. In some examples, the AI agent 202 utilizes the tools 206 (e.g., an OAM configuration tool) to interact with and configure the target NFs 210 such that the functional goal from the requesting NF 204 is achieved. Such configuration may include, for example, updating specific QoS values, triggering relocation procedures, or triggering reauthentication procedures. The target NFs 210 may provide feedback notifications, such as acknowledgments or status updates, to the AI agent 202 either directly or via the tools 206. In some implementations, the AI agent 202 may utilize data in the received notification to modify the actions and access the tools 206 again to interact with the target NFs 210. The procedures described above may be repeated in a loop until the request from the requesting NF 204 times out or until the functional goal is achieved.

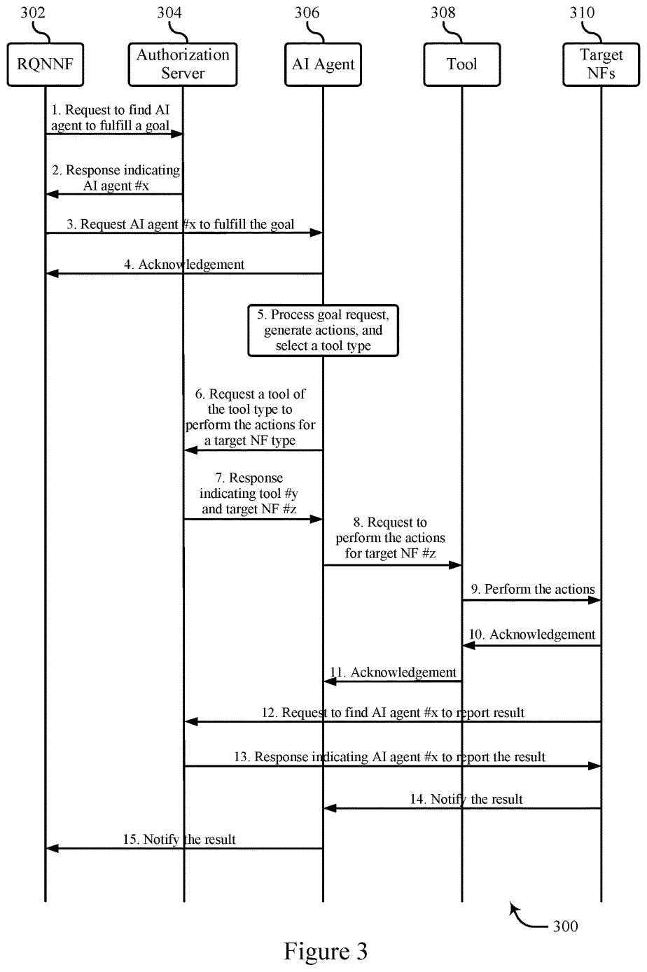

FIG. 3 illustrates an example procedure 300 of authorization of NFs involving an AI agent in accordance with aspects of the present disclosure. The procedure 300 illustrates a high-level authorization procedure to ensure full supervision of a NF with an AI agent (e.g., AI agent 306) in a network. In this example, the procedure 300 may be performed by a RQNNF 302 (e.g., a requesting NF), an authorization server 304 (e.g., an authorization NF), an AI agent 306, a tool 308 (e.g., a configuration tool NF), and one or more target NFs 310.

At step 1, the RQNNF 302 queries or requests the authorization server 304 to find an appropriate AI agent for achieving a specific goal (e.g., a functional goal). In some examples, the query from the RQNNF 302 may include a category indication associated with the goal to assist the authorization server 304 in selecting a corresponding AI agent, and may further include a time limitation and/or an expiry time for achieving the goal.

At step 2, the authorization server 304 authorizes the request and selects AI agent #x (i.e., the AI agent 306) to fulfill the goal of the RQNNF 302.

At step 3, the RQNNF 302 transmits a request (e.g., a first request) indicating the goal to the AI agent 306. In some implementations, the request contains a proof (e.g., an access token and/or client credentials assertion (CCA)) indicating that the request is authorized and originates from the RQNNF 302.

At step 4, the AI agent 306 may optionally transmit an acknowledgement of the request to the RQNNF 302.

At step 5, the AI agent 306 verifies the request, processes the goal, and generates or derives one or more actions and tools. In some examples, the AI agent 306 selects or determines a tool type and a target NF type to fulfill the goal.

At step 6, the AI agent 306 transmits an authorization request to the authorization server 304 for accessing the determined tool type and target NF type. In at least one implementation, the AI agent 306 includes the goal and the proof associated with the RQNNF 302 in the authorization request.

At step 7, the authorization server 304 verifies the proof associated with the RQNNF 302 and the request from the AI agent 306. The authorization server 304 selects a tool #y (i.e., the tool 308) for the AI agent 306 and authorizes target NF #z (i.e., the target NFs 310) to be configured via the tool 308.

At step 8, the AI agent 306 communicates with the tool 308 and requests (e.g., a second request) the determined actions to be performed for the target NF #z.

At step 9, the tool 308 performs or executes the requested actions on the target NFs 310.

At step 10, the target NFs 310 may transmit an acknowledgement of the request and the performed actions to the tool 308.

At step 11, the tool 308 may transmit an acknowledgement to the AI agent 306 indicating the execution of the requested actions.

At step 12, the target NFs 310 transmit a query or request to the authorization server 304 to request authorization for reporting results and/or sending notifications to the AI agent 306.

At step 13, the authorization server 304 authorizes the query or request from the target NFs 310. In some examples, the authorization server 304 indicates and/or identifies the AI agent #x for the target NFs 310 to report results to.

At step 14, the target NFs 310 transmit a result notification to the AI agent 306. In some implementations, the result notification may include additional information related to the requested actions, such as status information or a goal fulfillment status. Alternatively, the result notification may be transmitted to the AI agent 306 by the tool 308.

At step 15, the AI agent 306 transmits or forwards the result notification to the RQNNF 302.

In one or more implementations, the steps 5 through 14 described above may be repeated until the goal is achieved or until the request from the RQNNF 302 expires.

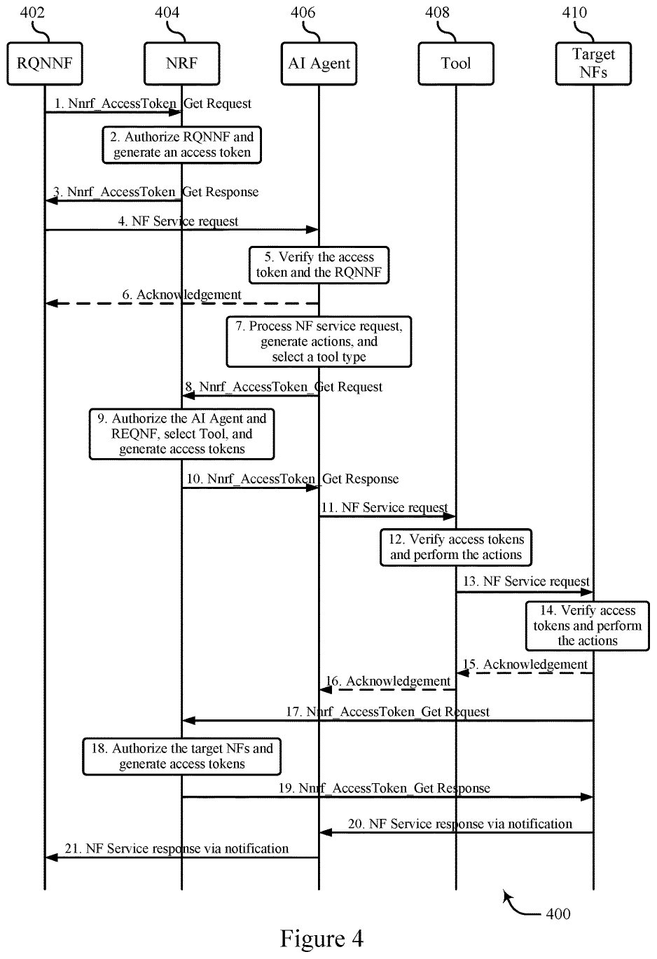

FIG. 4 illustrates an example procedure 400 of authorization of NFs involving an AI agent in accordance with aspects of the present disclosure. The procedure 400 illustrates detailed enhancements to a mobile network with Service Based Interfaces (SBI) performed by a RQNNF 402 (e.g., a requesting NF), a network repository function (NRF) 404 (e.g., an authorization NF), an AI agent 406, a tool 408 (e.g., a configuration tool NF), and one or more target NFs 410 (e.g., NF service producers). In this example, the AI agent 406 and the tool 408 are acting as NFs, such as an AMF. In some implementations, the security between the AI agent 406 and the tool 408 is similar to that of other NFs and realized with underlying transport security, such as transport layer security (TLS) or network domain security for IP-based protocols (NDS/IP), and authorization is required for actions the AI agent 406 is performing. In at least one implementation, the tool 408 is a MCP server.

At step 1, the RQNNF 402 transmits an access token request (e.g., Nnrf_AccessToken_Get request) to the NRF 404 to request an access token for accessing services of the AI agent 406 for fulfilling a functional goal. In some examples, the access token request may include an AI goal type (e.g., performance optimization, security verification, slice separation, or load balancing) and specific AI goal parameters (e.g., specific parameters to optimize, specific target NFs, target optimization improvement, or service types for reauthentication) used by the NRF 404 to select a specific AI agent instance.

At step 2, the NRF 404 verifies the access token request and generates an access token. In some implementations, the NRF 404 selects a specific AI agent instance (i.e., the AI agent 406) based on the AI goal type and the specific AI goal parameters.

At step 3, the NRF 404 transmits an access token response (e.g., Nnrf_AccessToken_Get response) to the RQNNF 402. In one or more implementations, the access token response includes one or more of the access token, an AI agent instance identifier (ID), and an expiry time for achieving the functional goal.

At step 4, the RQNNF 402 initiates an NF service request (e.g., a first request) to the AI agent 406 indicating the functional goal. In some implementations, the NF service request includes one or more of the access token associated with the RQNNF 402, the AI goal type, the AI goal parameters, and the expiry time for achieving the functional goal. Additionally or alternatively, the RQNNF 402 generates a client credentials assertion (CCA) token (e.g., CCA_REQNF) and includes it in the NF service request to authenticate itself toward other NFs (e.g., the AI agent 406, the tool 408, and/or the target NFs 410).

At step 5, the AI agent 406 verifies if the access token from the RQNNF 402 is valid. In some examples, the AI agent 406 also verifies the CCA token associated with the RQNNF 402.

At step 6, the AI agent 406 optionally acknowledges the receipt of the NF service request to the RQNNF 402.

At step 7, the AI agent 406 processes the NF service request and determines which actions (e.g., as described in the AI goal parameters) are to be performed to achieve the functional goal and which tool type is to be used. In this example, the AI agent 406 may determine a target NF type and/or the target NFs 410 associated with the target NF type to be configured or from where data is to be collected. In one or more implementations, the actions are described in AI action parameters, which further identify the target NF type and/or target parameters to be configured or modified.

At step 8, the AI agent 406 transmits an access token request (e.g., Nnrf_AccessToken_Get request) to the NRF 404. The access token request includes information to identify one or more of the target NFs 410, the source NF (e.g., the RQNNF 402), the NF instance ID of the AI agent 406, and the CCA provided by the RQNNF 402. In some examples, the access token request includes an nfInstanceId information element (IE) attribute indicating the NF instance ID of the AI agent 406 as an intermediate requesting NF, and/or a sourceNfInstanceId IE attribute indicating the source NF instance ID of the RQNNF 402. The access token request may further include one or more of the AI goal type, AI action parameters, and the tool type. In some examples, the AI agent 406 may also generate a CCA token (e.g., CCA_AI_AGENT) and include it in the access token request in order to authenticate itself toward the NRF 404, the tool 408, and/or the target NFs 410. In this example, the CCA of the AI agent 406 may be short-lived, such as being only valid for one round of tool invocation.

At step 9, the NRF 404 checks whether the AI agent 406 and the RQNNF 402 are allowed to access the services provided by the identified target NFs 410 via the tool 408, and whether the AI agent 406 is allowed to request the service from or configure the target NFs 410 on behalf of the RQNNF 402. By way of example, the NRF 404 authenticates both the AI agent 406 and the RQNNF 402 based on one or more service-based architecture (SBA) methods that consider the AI goal type, the AI action parameters, and the tool type. In one or more implementations, the NRF 404 selects an instance ID of the tool 408 based on the AI goal type, the AI goal parameters, and the tool type. For instance, the NRF 404 may act as a MCP server to select a tool.

At step 10, the NRF 404 generates and transmits an access token response (e.g., Nnrf_AccessToken_Get response) to the AI agent 406. The access token response includes an access token (e.g., access_token_ai_agent) for the AI agent 406 with the NF instance ID of the AI agent 406, and/or an additional access token claim containing the identity of the source RQNNF 402. The access token response may also include an access token (e.g., access_token_tool) for the tool 408 to access the target NFs 410 with an additional access token claim containing the identity of the AI agent 406.

At step 11, the AI agent 406 transmits a NF service request to the tool 408 to request service from the tool 408 to collect data and/or configure the target NFs 410. In some implementations, the NF service request contains one or more of the CCA of the RQNNF 402 (e.g., CCA_REQNF), the CCA of the AI agent 406 (e.g., CCA_AI_AGENT), the access token of the AI agent 406, the access token of the tool 408, and/or specific actions described by the AI action parameters.

At step 12, the tool 408 verifies the access tokens contained in the NF service request and performs the actions described in the AI goal parameters.

At step 13, the tool 408 transmits a NF service request on behalf of the AI agent 406 to the target NFs 410 to apply the actions determined by the AI agent 406. By way of example, the NF service request contains the CCA of the RQNNF 402 (e.g., CCA_RQNNF) and the CCA of the AI agent 406 (CCA_AI_AGENT) so that the target NFs 410 may authenticate the RQNNF 402 and the AI agent 406. For instance, the NF service producers (i.e., the target NFs 410) may check the subject claim of CCA_REQNF with the access token claim of the tool 408 conveying the source NF Instance ID, as well as the nfInstanceId IE attribute in the access token request that indicates the NF instance ID of the AI agent 406 as an intermediate requesting NF. In some implementations, selection of the target NFs 410 is performed by the NRF 404 at step 9, or alternatively by the tool 408 at step 12.

At step 14, the target NFs 410 verify the received access tokens, authenticate the RQNNF 402, and ensure that the source RQNNF identity is included as an access token additional claim. Additionally, the target NFs 410 authenticate and authorize the AI agent 406. Upon successful authentication and authorization, the target NFs 410 execute the service or the requested actions.

At step 15, the target NFs 410 may optionally acknowledge receipt of the NF service request to the tool 408.

At step 16, the tool 408 may optionally forward the acknowledgement to the AI agent 406.

At step 17, the target NFs 410 transmit an access token request (e.g., Nnrf_AccessToken_Get request) to the NRF 404 to request an access token to provide notifications to the AI agent 406. In one or more implementations, the target NFs 410 include the CCA of the AI agent 406 (e.g., CCA_AI_AGENT) in the access token request so that only those target NFs 410 can directly access the AI agent 406, ensuring other NFs from the same target NF type but not a part of the target NFs 410 are disallowed to communicate with the AI agent 406. The procedure described in step 17 ensures NF service producers do not provide unrelated data to the AI agent 406 and lead to incorrect decisions of the AI agent 406.

At step 18, the NRF 404 verifies the access token request, authorizes the target NFs 410, and generates access tokens for the target NFs 410 upon successful verification and authorization.

At step 19, the NRF 404 transmits an access token response (e.g., Nnrf_AccessToken_Get response) containing the access tokens to the target NFs 410.

At step 20, the target NFs 410 transmit a NF service response via notification to the AI agent 406. The NF service response includes data related to the requested actions and the access tokens of the target NFs 410 to the AI agent 406. Alternatively, the target NFs 410 may provide the data related to the requested actions to the tool 408, which then accumulates the data and transmits the NF service response via notification to the AI agent 406. In this example where the target NFs 410 do not directly communicate with the AI agent 406, one or more of steps 17-19 described above may be skipped.

At step 21, the AI agent 406 verifies the access tokens and the received data related to the requested actions, and transmits or forwards the NF service response via notification to the RQNNF 402. Additionally or alternatively, the AI agent 406 notifies the RQNNF 402 of a goal fulfillment status. In some implementations, the AI agent 406 checks whether the requested functional goal is achieved and/or whether the time for fulfilling the functional goal has expired. In this example, if the functional goal is not achieved and the time for fulfilling the functional goal has not expired, the AI agent 406 performs another round of processing and repeats the described procedure from step 7.

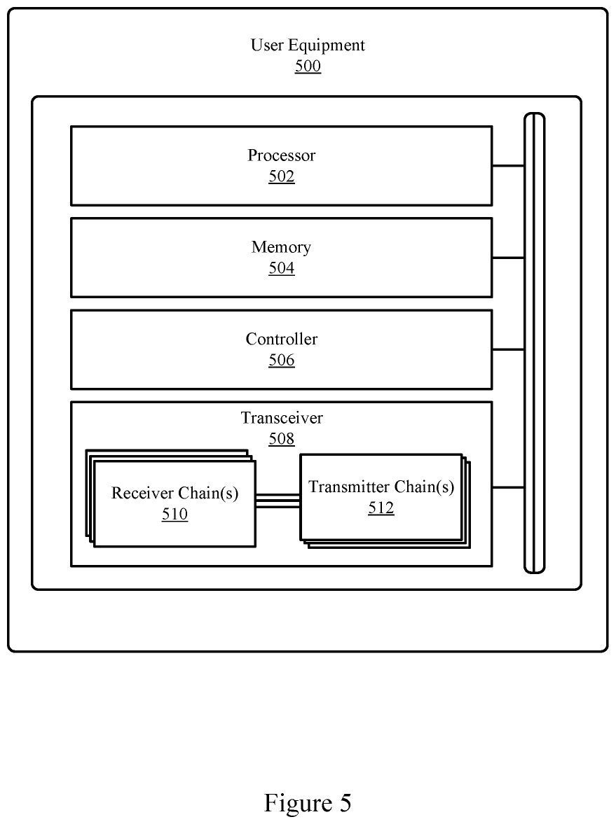

FIG. 5 illustrates an example of a UE 500 in accordance with aspects of the present disclosure. In some examples, the UE 500 may be an example of a UE as described with reference to FIGS. 1-4. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field-programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

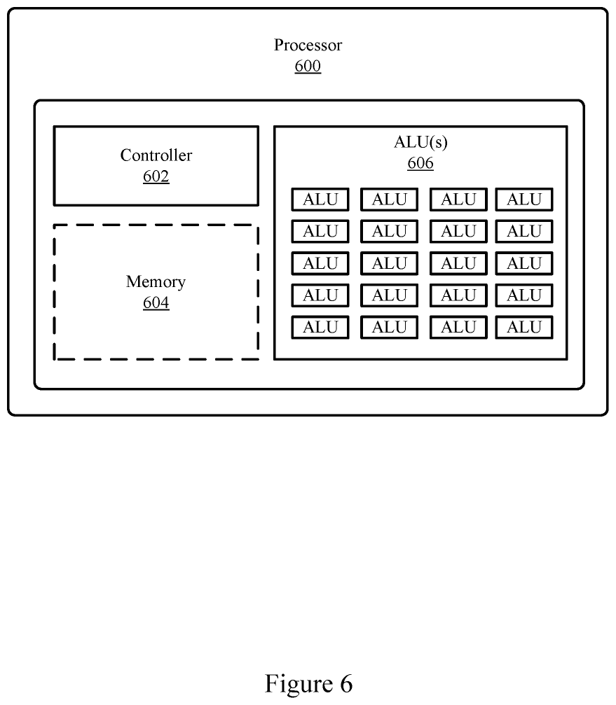

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to support at least one controller (e.g., the controller 602) coupled with at least one memory (e.g., the memory 604) and configured to or operable to cause the processor to receive a first request indicating a function goal; determine, by an AI agent and in response to authentication of the first request, a configuration tool type to perform one or more actions associated with a target NF type to fulfill the function goal; transmit an access token request for authorization to access one or more NFs associated with at least one of the configuration tool type or the target NF type; receive an access token response authorizing access to the target NF type and access to a configuration tool NF associated with the configuration tool type; transmit a second request to perform the one or more actions for one or more target NFs associated with the target NF type; receive information associated with the one or more actions; and transmit a goal fulfillment status based at least in part on the information associated with the one or more actions.

Additionally, or alternatively, the processor 600 may be configured to or operable to support the first request is received in response to the requesting NF obtaining authorization from the authorization NF to access the NF. Additionally, the processor 600 may be configured to or operable to support the first request includes one or more of an access token of the requesting NF to the NF, a type of the function goal, one or more goal parameters, an expiry time, or a client credentials assertion (CCA) associated with the requesting NF.

Additionally, or alternatively, the processor 600 may be configured to or operable to support to validate the access token of the requesting NF to the NF and the CCA associated with the requesting NF.

Additionally, or alternatively, the processor 600 may be configured to or operable to support the configuration tool type and the one or more actions associated with the target NF type are identified in one or more action parameters.

Additionally, or alternatively, the processor 600 may be configured to or operable to support to generate, using the AI agent, a CCA associated with the NF that is valid for a single invocation of the configuration tool NF.

Additionally, or alternatively, the processor 600 may be configured to or operable to support the access token request includes one or more of a type of the function goal, one or more goal parameters, the configuration tool type, the target NF type, an expiry time, a CCA associated with the requesting NF, or a CCA associated with the NF. Additionally, the processor 600 may be configured to or operable to support the access token response includes an access token of the NF to the configuration tool NF, and an access token of the configuration tool NF to the one or more target NFs associated with the target NF type.

Additionally, or alternatively, the processor 600 may be configured to or operable to support the one or more target NFs are determined by either the authorization NF or the configuration tool NF.

Additionally, or alternatively, the processor 600 may be configured to or operable to support the second request includes one or more of an access token of the NF to the configuration tool NF, an access token of the configuration tool NF to the one or more target NFs associated with the target NF type, a list of the one or more target NFs, the target NF type, a type of the function goal, one or more goal parameters, a CCA of the requesting NF, a CCA of the NF, or one or more action parameters associated with the one or more actions.

Additionally, or alternatively, the processor 600 may be configured to or operable to support the information associated with the one or more actions includes one or more access tokens of the one or more target NFs to the NF.

Additionally, or alternatively, the processor 600 may be configured to or operable to support to determine, by the AI agent based at least in part on the first request, one or more additional actions associated with the target NF type, in response to the function goal not being fulfilled by the one or more actions and an expiry time not being reached; and transmit, to the authorization NF, another access token request for the one or more additional actions.

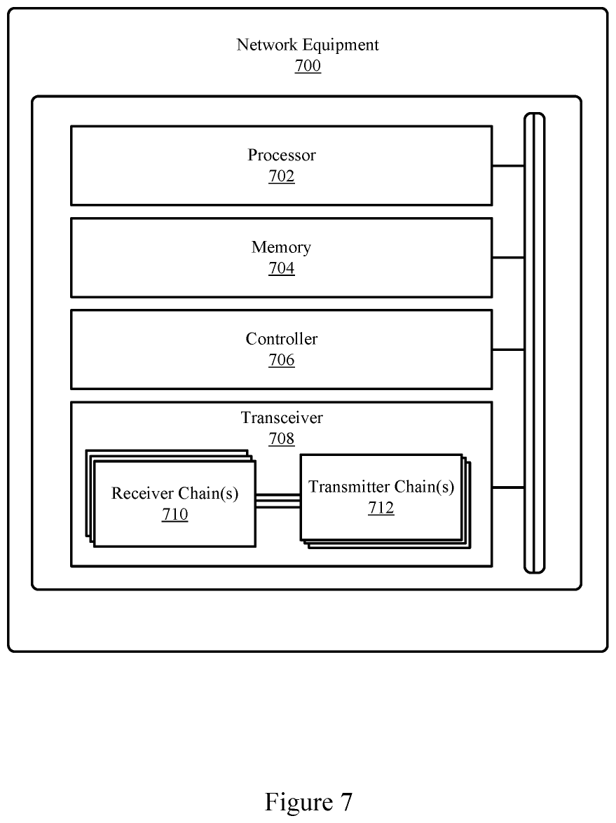

FIG. 7 illustrates an example of an NE 700 in accordance with aspects of the present disclosure. In some examples, the NE 700 may be an example of an NE (e.g., a network server with a NF) as described with reference to FIGS. 1-4. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for receiving, from a requesting NF, a first request indicating a function goal; determining, by an AI agent and in response to authentication of the first request, a configuration tool type to perform one or more actions associated with a target NF type to fulfill the function goal; transmitting, to an authorization NF, an access token request for authorization to access one or more NFs associated with at least one of the configuration tool type or the target NF type; receiving, from the authorization NF, an access token response authorizing access to the target NF type and access to a configuration tool NF associated with the configuration tool type; transmitting, to the configuration tool NF, a second request to perform the one or more actions for one or more target NFs associated with the target NF type; receiving, from the configuration tool NF or the one or more target NFs, information associated with the one or more actions; and transmitting, to the requesting NF, a goal fulfillment status based at least in part on the information associated with the one or more actions.

Additionally, or alternatively, the NE 700 may be configured to or operable to support the first request is received in response to the requesting NF obtaining authorization from the authorization NF to access the NF. Additionally, or alternatively, the NE 700 may be configured to or operable to support the first request includes one or more of an access token of the requesting NF to the NF, a type of the function goal, one or more goal parameters, an expiry time, or a client credentials assertion (CCA) associated with the requesting NF.

Additionally, or alternatively, the NE 700 may be configured to or operable to support to validate the access token of the requesting NF to the NF and the CCA associated with the requesting NF.

Additionally, or alternatively, the NE 700 may be configured to or operable to support the configuration tool type and the one or more actions associated with the target NF type are identified in one or more action parameters.

Additionally, or alternatively, the NE 700 may be configured to or operable to support to generate, using the AI agent, a CCA associated with the NF that is valid for a single invocation of the configuration tool NF.

Additionally, or alternatively, the NE 700 may be configured to or operable to support the access token request includes one or more of a type of the function goal, one or more goal parameters, the configuration tool type, the target NF type, an expiry time, a CCA associated with the requesting NF, or a CCA associated with the NF. Additionally, or alternatively, the NE 700 may be configured to or operable to support the access token response includes an access token of the NF to the configuration tool NF, and an access token of the configuration tool NF to the one or more target NFs associated with the target NF type.

Additionally, or alternatively, the NE 700 may be configured to or operable to support the one or more target NFs are determined by either the authorization NF or the configuration tool NF.

Additionally, or alternatively, the NE 700 may be configured to or operable to support the second request includes one or more of an access token of the NF to the configuration tool NF, an access token of the configuration tool NF to the one or more target NFs associated with the target NF type, a list of the one or more target NFs, the target NF type, a type of the function goal, one or more goal parameters, a CCA of the requesting NF, a CCA of the NF, or one or more action parameters associated with the one or more actions.

Additionally, or alternatively, the NE 700 may be configured to or operable to support the information associated with the one or more actions includes one or more access tokens of the one or more target NFs to the NF.

Additionally, or alternatively, the NE 700 may be configured to or operable to support to determine, by the AI agent based at least in part on the first request, one or more additional actions associated with the target NF type, in response to the function goal not being fulfilled by the one or more actions and an expiry time not being reached; and transmit, to the authorization NF, another access token request for the one or more additional actions.

Additionally, or alternatively, the NE 700 may support at least one memory (e.g., the memory 704) and at least one processor (e.g., the processor 702) coupled with the at least one memory and configured to or operable to cause the NE to receive a first request indicating a function goal; determine, by an AI agent and in response to authentication of the first request, a configuration tool type to perform one or more actions associated with a target NF type to fulfill the function goal; transmit an access token request for authorization to access one or more NFs associated with at least one of the configuration tool type or the target NF type; receive an access token response authorizing access to the target NF type and access to a configuration tool NF associated with the configuration tool type; transmit a second request to perform the one or more actions for one or more target NFs associated with the target NF type; receive information associated with the one or more actions; and transmit a goal fulfillment status based at least in part on the information associated with the one or more actions.

Additionally, or alternatively, the NE 700 may be configured to or operable to support the at least one processor configured to or operable to cause the NE 700 to support the first request is received in response to the requesting NF obtaining authorization from the authorization NF to access the NF. Additionally, or alternatively, the NE 700 may be configured to or operable to support the at least one processor configured to or operable to cause the NE 700 to support the first request includes one or more of an access token of the requesting NF to the NF, a type of the function goal, one or more goal parameters, an expiry time, or a client credentials assertion (CCA) associated with the requesting NF.

Additionally, or alternatively, the NE 700 may be configured to or operable to support the at least one processor configured to or operable to cause the NE 700 to validate the access token of the requesting NF to the NF and the CCA associated with the requesting NF.

Additionally, or alternatively, the NE 700 may be configured to or operable to support the at least one processor configured to or operable to cause the NE 700 to support the configuration tool type and the one or more actions associated with the target NF type are identified in one or more action parameters.

Additionally, or alternatively, the NE 700 may be configured to or operable to support the at least one processor configured to or operable to cause the NE 700 to generate, using the AI agent, a CCA associated with the NF that is valid for a single invocation of the configuration tool NF.

Additionally, or alternatively, the NE 700 may be configured to or operable to support the at least one processor configured to or operable to cause the NE 700 to support the access token request includes one or more of a type of the function goal, one or more goal parameters, the configuration tool type, the target NF type, an expiry time, a CCA associated with the requesting NF, or a CCA associated with the NF. Additionally, or alternatively, the NE 700 may be configured to or operable to support the access token response includes an access token of the NF to the configuration tool NF, and an access token of the configuration tool NF to the one or more target NFs associated with the target NF type.

Additionally, or alternatively, the NE 700 may be configured to or operable to support the at least one processor configured to or operable to cause the NE 700 to support the one or more target NFs are determined by either the authorization NF or the configuration tool NF.

Additionally, or alternatively, the NE 700 may be configured to or operable to support the at least one processor configured to or operable to cause the NE 700 to support the second request includes one or more of an access token of the NF to the configuration tool NF, an access token of the configuration tool NF to the one or more target NFs associated with the target NF type, a list of the one or more target NFs, the target NF type, a type of the function goal, one or more goal parameters, a CCA of the requesting NF, a CCA of the NF, or one or more action parameters associated with the one or more actions.

Additionally, or alternatively, the NE 700 may be configured to or operable to support the at least one processor configured to or operable to cause the NE 700 to support the information associated with the one or more actions includes one or more access tokens of the one or more target NFs to the NF.

Additionally, or alternatively, the NE 700 may be configured to or operable to support the at least one processor configured to or operable to cause the NE 700 to determine, by the AI agent based at least in part on the first request, one or more additional actions associated with the target NF type, in response to the function goal not being fulfilled by the one or more actions and an expiry time not being reached; and transmit, to the authorization NF, another access token request for the one or more additional actions.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., an LNA) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

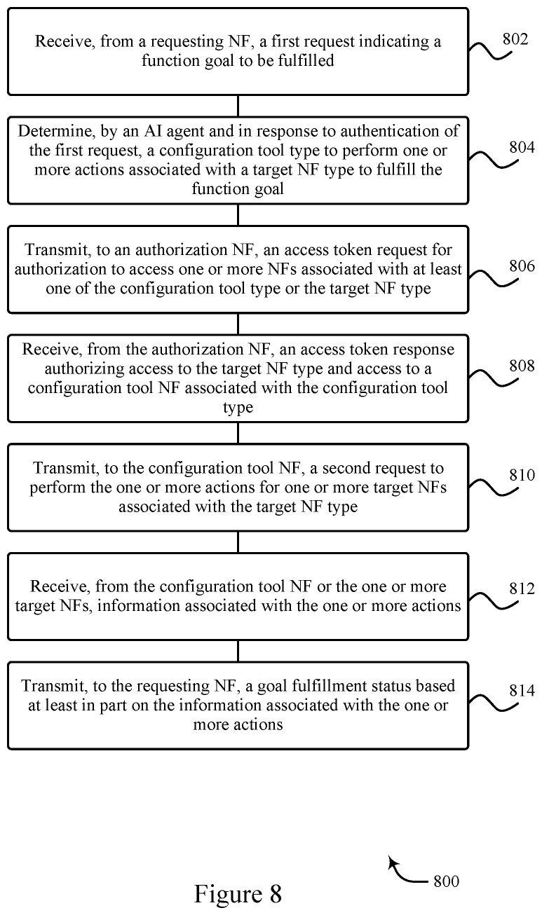

FIG. 8 illustrates a flowchart of a method 800 in accordance with aspects of the present disclosure. The operations of the method may be implemented by an NE as described herein (e.g., a network server with a NF). In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include receiving, from a requesting NF, a first request indicating a function goal. The operations of 802 may be performed in accordance with examples as described herein. In some implementations, aspects of the operations of 802 may be performed by the NE 700 as described with reference to FIG. 7.

At 804, the method may include determining, by an AI agent and in response to authentication of the first request, a configuration tool type to perform one or more actions associated with a target NF type to fulfill the function goal. The operations of 804 may be performed in accordance with examples as described herein. In some implementations, aspects of the operations of 804 may be performed by the NE 700 as described with reference to FIG. 7.

At 806, the method may include transmitting, to an authorization NF, an access token request for authorization to access one or more NFs associated with at least one of the configuration tool type or the target NF type. The operations of 806 may be performed in accordance with examples as described herein. In some implementations, aspects of the operations of 806 may be performed by the NE 700 as described with reference to FIG. 7.

At 808, the method may include receiving, from the authorization NF, an access token response authorizing access to the target NF type and access to a configuration tool NF associated with the configuration tool type. The operations of 808 may be performed in accordance with examples as described herein. In some implementations, aspects of the operations of 808 may be performed by the NE 700 as described with reference to FIG. 7.

At 810, the method may include transmitting, to the configuration tool NF, a second request to perform the one or more actions for one or more target NFs associated with the target NF type. The operations of 810 may be performed in accordance with examples as described herein. In some implementations, aspects of the operations of 810 may be performed by the NE 700 as described with reference to FIG. 7.

At 812, the method may include receiving, from the configuration tool NF or the one or more target NFs, information associated with the one or more actions. The operations of 812 may be performed in accordance with examples as described herein. In some implementations, aspects of the operations of 812 may be performed by the NE 700 as described with reference to FIG. 7.

At 814, the method may include transmitting, to the requesting NF, a goal fulfillment status based at least in part on the information associated with the one or more actions. The operations of 814 may be performed in accordance with examples as described herein. In some implementations, aspects of the operations of 814 may be performed by the NE 700 as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network server with a network function (NF) for wireless communication, the network server comprising:
at least one memory; and
at least one processor coupled with the at least one memory and operable to cause the NF to:
receive, from a requesting NF, a first request indicating a function goal;
determine, by an artificial intelligence (AI) agent and in response to authentication of the first request, a configuration tool type to perform one or more actions associated with a target NF type to fulfill the function goal;
transmit, to an authorization NF, an access token request for authorization to access one or more NFs associated with at least one of the configuration tool type or the target NF type;
receive, from the authorization NF, an access token response authorizing access to the target NF type and access to a configuration tool NF associated with the configuration tool type;
transmit, to the configuration tool NF, a second request to perform the one or more actions for one or more target NFs associated with the target NF type;
receive, from the configuration tool NF or the one or more target NFs, information associated with the one or more actions; and
transmit, to the requesting NF, a goal fulfillment status based at least in part on the information associated with the one or more actions.

2. The network server of claim 1, wherein the first request is received in response to the requesting NF obtaining authorization from the authorization NF to access the NF.

3. The network server of claim 1, wherein the first request includes one or more of:
an access token of the requesting NF to the NF;
a type of the function goal;
one or more goal parameters;
an expiry time; or a client credentials assertion (CCA) associated with the requesting NF.

4. The network server of claim 3, wherein the at least one processor is operable to cause the NF to validate the access token of the requesting NF to the NF and the CCA associated with the requesting NF.

5. The network server of claim 1, wherein the configuration tool type and the one or more actions associated with the target NF type are identified in one or more action parameters.

6. The network server of claim 1, wherein the at least one processor is operable to cause the NF to generate, using the AI agent, a client credentials assertion (CCA) associated with the NF that is valid for a single invocation of the configuration tool NF.

7. The network server of claim 1, wherein the access token request includes one or more of:
a type of the function goal;
one or more goal parameters;
the configuration tool type;
the target NF type;
an expiry time;
a client credentials assertion (CCA) associated with the requesting NF; or
a CCA associated with the NF.

8. The network server of claim 1, wherein the access token response includes an access token of the NF to the configuration tool NF, and an access token of the configuration tool NF to the one or more target NFs associated with the target NF type.

9. The network server of claim 1, wherein the one or more target NFs are determined by either the authorization NF or the configuration tool NF.

10. The network server of claim 1, wherein the second request includes one or more of:
an access token of the NF to the configuration tool NF;
an access token of the configuration tool NF to the one or more target NFs associated with the target NF type;
a list of the one or more target NFs;
the target NF type;
a type of the function goal;
one or more goal parameters;
a client credentials assertion (CCA) of the requesting NF;
a CCA of the NF; or
one or more action parameters associated with the one or more actions.

11. The network server of claim 1, wherein the information associated with the one or more actions includes one or more access tokens of the one or more target NFs to the NF.

12. The network server of claim 1, wherein the at least one processor is operable to cause the NF to:
determine, by the AI agent based at least in part on the first request, one or more additional actions associated with the target NF type, in response to the function goal not being fulfilled by the one or more actions and an expiry time not being reached; and
transmit, to the authorization NF, another access token request for the one or more additional actions.

13. A method performed by a network function (NF), the method comprising:
receiving, from a requesting NF, a first request indicating a function goal;
determining, by an artificial intelligence (AI) agent and in response to authentication of the first request, a configuration tool type to perform one or more actions associated with a target NF type to fulfill the function goal;
transmitting, to an authorization NF, an access token request for authorization to access one or more NFs associated with at least one of the configuration tool type or the target NF type;
receiving, from the authorization NF, an access token response authorizing access to the target NF type and access to a configuration tool NF associated with the configuration tool type;
transmitting, to the configuration tool NF, a second request to perform the one or more actions for one or more target NFs associated with the target NF type;
receiving, from the configuration tool NF or the one or more target NFs, information associated with the one or more actions; and
transmitting, to the requesting NF, a goal fulfillment status based at least in part on the information associated with the one or more actions.

14. The method of claim 13, wherein the first request is received in response to the requesting NF obtaining authorization from the authorization NF to access the NF.

15. The method of claim 13, wherein the first request includes one or more of:
an access token of the requesting NF to the NF;
a type of the function goal;
one or more goal parameters;
an expiry time; or
a client credentials assertion (CCA) associated with the requesting NF.

16. The method of claim 15, wherein, for authentication of the first request, the method further comprises:
validating the access token of the requesting NF to the NF and the CCA associated with the requesting NF.

17. The method of claim 13, further comprising:
generating, using the AI agent, a client credentials assertion (CCA) associated with the NF that is valid for a single invocation of the configuration tool NF.

18. The method of claim 13, wherein the second request includes one or more of:
an access token of the NF to the configuration tool NF;
an access token of the configuration tool NF to the one or more target NFs associated with the target NF type;
a list of the one or more target NFs;
the target NF type;
a type of the function goal;
one or more goal parameters;
a client credentials assertion (CCA) of the requesting NF;
a CCA of the NF; or
one or more action parameters associated with the one or more actions.

19. The method of claim 13, further comprising:
determining, by the AI agent based at least in part on the first request, one or more additional actions associated with the target NF type, in response to the function goal not being fulfilled by the one or more actions and an expiry time not being reached; and
transmitting, to the authorization NF, another access token request for the one or more additional actions.

20. A processor for wireless communication, comprising:
at least one controller coupled with at least one memory and operable to cause the processor to:
receive a first request indicating a function goal;
determine, by an artificial intelligence (AI) agent and in response to authentication of the first request, a configuration tool type to perform one or more actions associated with a target NF type to fulfill the function goal;
transmit an access token request for authorization to access one or more NFs associated with at least one of the configuration tool type or the target NF type;
receive an access token response authorizing access to the target NF type and access to a configuration tool NF associated with the configuration tool type;
transmit a second request to perform the one or more actions for one or more target NFs associated with the target NF type;
receive information associated with the one or more actions; and
transmit a goal fulfillment status based at least in part on the information associated with the one or more actions.
